(19) United States
(12) Patent Application Publication
(10) Pub. No.: US 2014/0037366 A1
(43) Pub. Date: Feb. 6, 2014

(54) GRID RUNNER INTERSECTION CLIP

(71) Applicants: Peter B. Groza, Spring Grove, IL (US); Peder J. Gulbrandsen, Aurora, IL (US); Mark R. Paulsen, Beach Park, IL (US); Abraham M. Underkofler, Waukegan, IL (US)

(72) Inventors: Peter B. Groza, Spring Grove, IL (US); Peder J. Gulbrandsen, Aurora, IL (US); Mark R. Paulsen, Beach Park, IL (US); Abraham M. Underkofler, Waukegan, IL (US)

(73) Assignee: USG INTERIORS, LLC, Chicago, IL (US)

(21) Appl. No.: 13/562,360

(22) Filed: Jul. 31, 2012

(51) Int. Cl. F16B 7/00

(52) U.S. Cl. 403/171

(57) ABSTRACT

A sheet metal clip for connecting the ends of three or four grid runners with their longitudinal axii intersecting at a common center and at obtuse or acute angles relative to each other, the clip having a leg for each one of the grid runners, each leg, in use, extending in a vertical plane from the center and being permanently bendable at the center to allow the leg to be adjusted to a desired angle of a respective grid runner.

### BACKGROUND OF THE INVENTION

The invention relates to suspended ceiling systems and, in particular, to a clip for connecting multiple grid runners.

### PRIOR ART

Suspended ceilings typically comprise a metal grid that supports ceiling panels. Most suspended grid is arranged in a rectangular pattern and the means for connecting orthogonal intersections of the grid elements is well developed. For the most part, known connectors are only suitable for connecting the grid runners end to end in a straight line. Architects and interior designers can create grid designs that are not rectangular for a distinctive appearance. However, grid runner end connections for these applications are not generally available. Contractors can create non-rectangular grids specified by a designer. Such work can be very labor intensive and require a high level of skill to obtain a satisfactory, craftsman level appearance. This expense and difficulty will be experienced where there is no end connector available to join more than two grid runner ends together at a common intersection.

### SUMMARY OF THE INVENTION

The invention provides a clip for joining the ends of multiple grid runners at a common intersection. The clip is field adjustable to accommodate any practical grid runner angular relationship in a single plane.

The inventive clip is effective to horizontally and vertically align the intersecting grid runners. The clip is advantageously capable of being assembled and interlocked with the grid runners without fasteners. A connection between the clip and a grid runner is effected by simply inserting a tab of the clip into a slot formed in a web of the grid runner and then reverse bending the tab over the web. The disclosed clip is preferably a unitary sheet metal stamping of relatively soft steel.

In a preferred embodiment, the clip has three legs, each adapted to couple with a respective grid runner. Each leg can be bent at a common intersection to obtain a desired angular orientation relative to the other legs corresponding to the desired orientation of the grid runners. Thus, the clip can be employed in various grid patterns including hexagons, diamonds, and other polygons as well as radial spiderweb-like arrangements.

### BRIEF DESCRIPTION OF THE DRAWINGS

FIG. 1 is a perspective view of the inventive clip;

FIG. 2 is a planar view of a blank from which the clip of FIG. 1 is made;

FIG. 3 is a perspective view of the clip of FIG. 1 in an exploded relation to the ends of two grid runners;

FIG. 4 is a side view of the assembled relation between a connector leg and grid runner;

FIG. 5 is a cross-sectional view taken in the plane 5-5 in FIG. 4;

FIG. 6 is a diagrammatic fragmentary view of a hex or beehive grid pattern in which the clip is used at intersections of the grid runners;

FIG. 7 is a fragmentary view of a radial or spiderweb grid pattern;

FIG. 8 is a plan view of a blank of a clip for the intersection of four grid runners; and

FIG. 9 is a perspective view of the inventive clip made from the blank of FIG. 8.

### DESCRIPTION OF THE PREFERRED EMBODIMENT

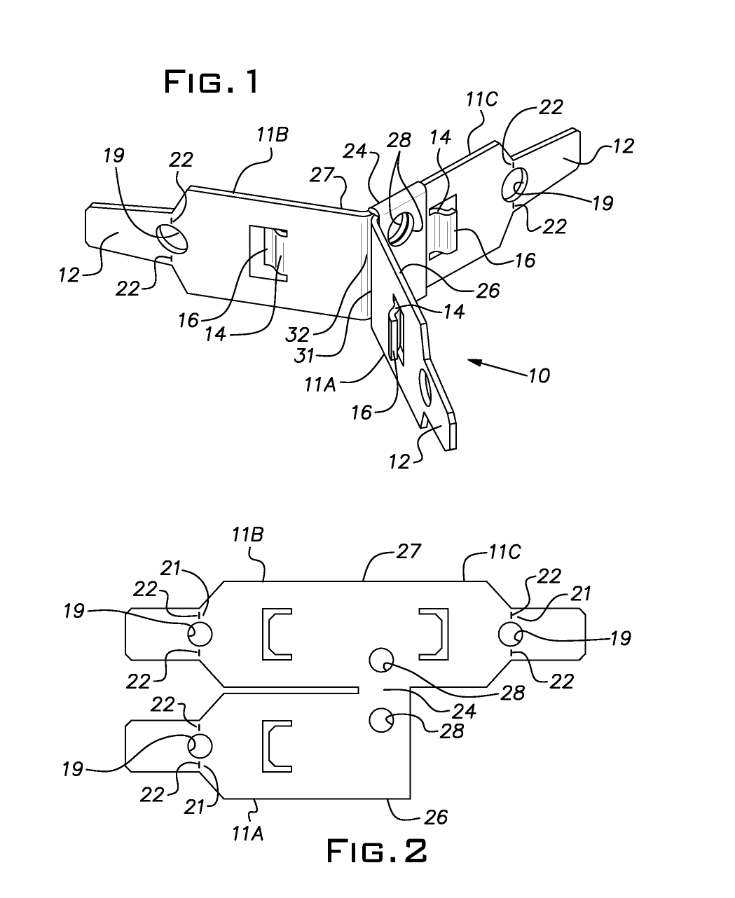

FIG. 1 illustrates a clip 10 of the invention suitable for joining three grid runners end to end. The clip 10 is blanked as a single body from sheet metal such as hot dipped galvanized steel. FIG. 2 shows a flat blank preform of the clip 10. The clip 10 has three legs 11, each leg having a distal tab 12 and an intermediate catch or hook 13. The catch 13 is blanked out of the mid-area of a leg 11. The catch 13, as shown in FIG. 5 in an edge view, is formed in part by a web 14 extending laterally from the plane of the leg 11. At a distal end of the web 14 the catch 13 has a flat finger section 16 spaced from the plane of the main part of the leg 11, i.e. the leg proper. The height of the web 14 and spacing of the finger section 16 from the plane of the leg proper is arranged so that a lead end of a grid runner 17 can be received between the leg proper and finger section.

A hole 19 at the junction of a tab 12 and the leg proper leaves the tab connected to the leg proper at two small land areas 21. The hole 19 creates a weakened area so that a lateral force on the tab will cause it to bend along an imaginary line 22 connecting the land areas 21.

A land area 24 connects a part 26 of the clip body associated with one of the legs 11A to another part 27 associated with two other legs 11B, 11C. Holes 28 are punched in the parts 26, 27 for receiving a suspension wire or wires. The parts 26, 27 are folded at the land area 24 against one another. In the folded configuration, the holes 28 are aligned.

The body parts 26, 27 are bent at respective lines 31, 32 adjacent an edge 33 of the land area 24. The result is a Y-shaped configuration of the clip 10 when the clip is viewed from its top or bottom. The tabs 12 can be pre-bent at the imaginary lines 22 so that they lie in obtuse or right angles to their respective legs 11.

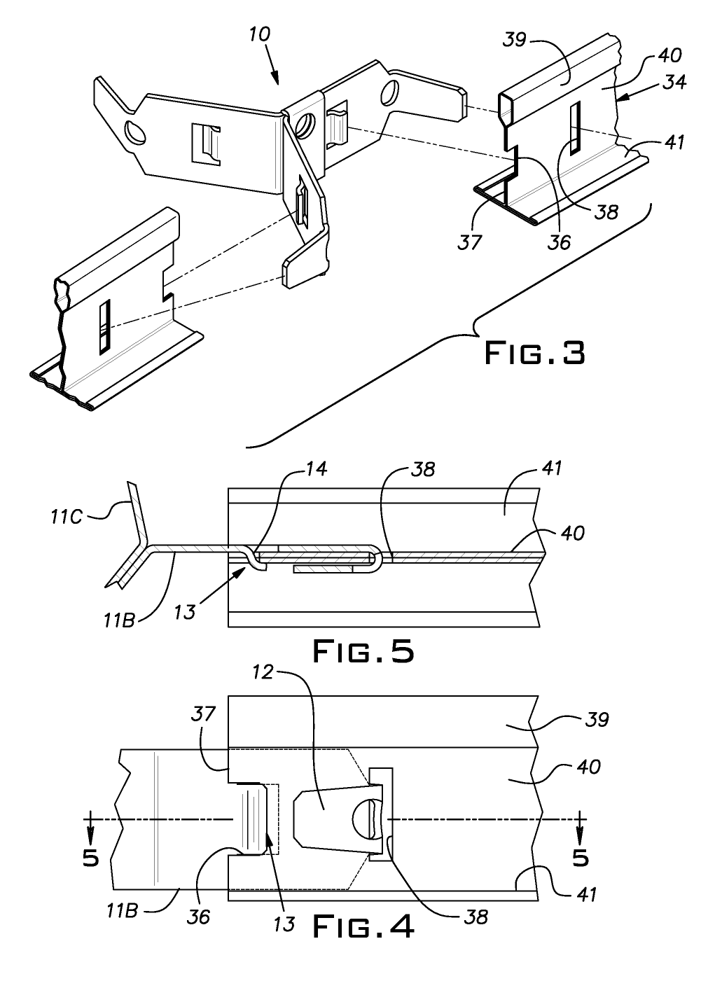

The clip 10 is adapted to join the ends of three grid runners 34. Ends of two grid runners 34 is illustrated in FIG. 3 in exploded relation to one of the clip legs 11. The legs 11A, B, C, in areas where they connect to a grid runner are identical. Each grid runner 34, which in the illustrated example has a conventional tee configuration, has its end arranged to mate with the geometry of one of the clip legs 11. This arrangement includes a notch 36 in a leading edge 37 of the runner 34 and a vertical slot 38 spaced rearwardly of the leading edge 37. The notch 36 is proportioned to receive the web 14 of the catch 13 and the slot 38 is proportioned to receive a tab 12 of a leg 11. The vertical height of a leg 11 is dimensioned to provide a close fit in a space between a reinforcing bulb 39 and a lower flange 41 of the grid runner 34.

The end of the grid runner 34 is assembled on a clip by inserting the tab 12 in the slot 38 and initially guiding the lead edge 37 of the runner 35 between the catch finger section 16 and the leg proper. When the tab 12 is fully received in the slot 38, the lead edge 37 is captured in the catch 13. The finger section 16 laterally restricts the lead edge 37 and the catch web 14, received in the notch 36, vertically restricts the lead edge.

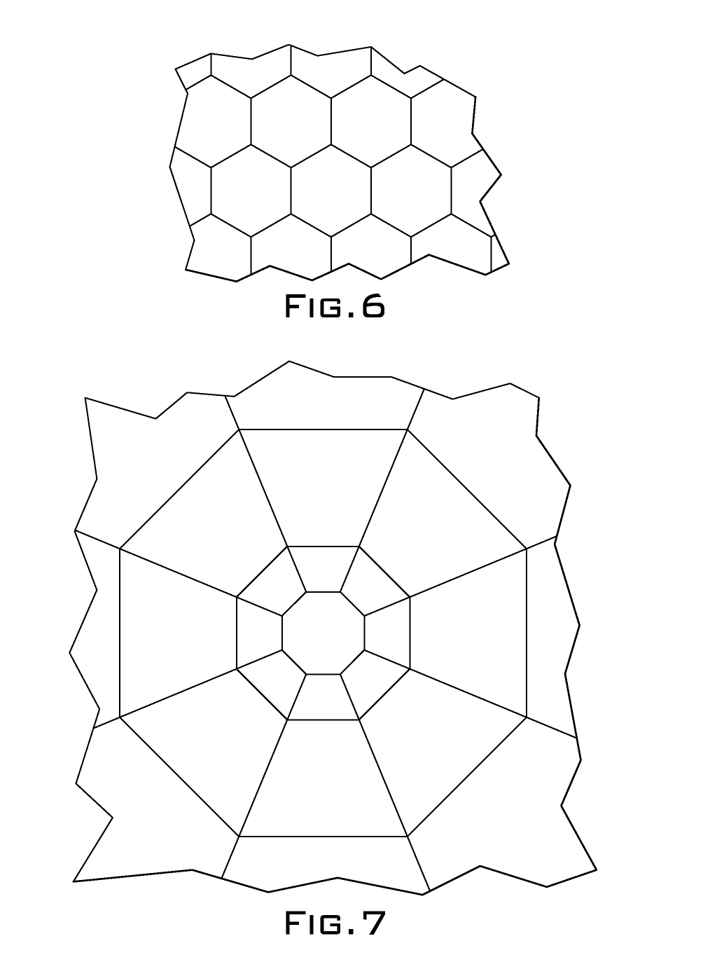

With the grid runner web, designated 40, abutted against the leg 11, the tab 12 can be manually bent forwardly towards the catch 13 to securely lock the end of the grid runner 34 and clip 10 together as shown in FIG. 5. Two other grid runners 34 are joined to the clip 10 in the same manner. The clip 10 serves to align the grid runners 34 so that their longitudinal axii intersect at the center of a clip where the legs 11 are bent on the lines 31, 32. The clip 10 can be supplied to the trade with the legs 11 spaced at 120 degrees. However, the legs 11 can be bent on site to accommodate a desired pattern of a grid configuration. FIG. 6 illustrates an example of grid runners arranged in a hexagon pattern.

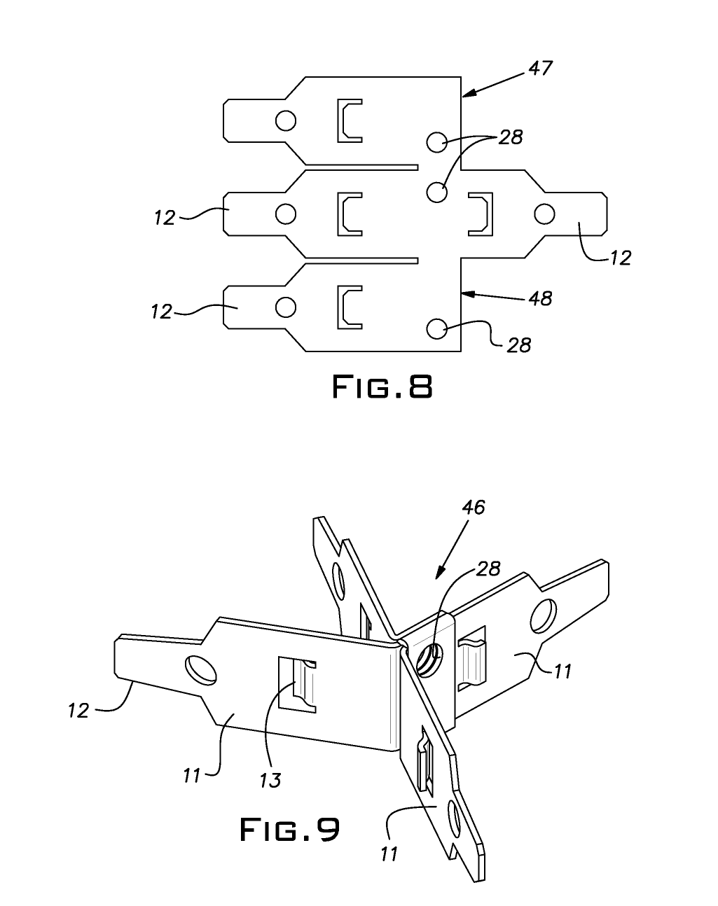

FIG. 7 demonstrates a radial grid runner pattern in which four runners intersect at a common junction. FIG. 8 illustrates a variation of the clip arranged to connect four grid runner ends. The same numerals used in connection with the description of the clip 10 are used to designate the same or equivalent parts of this four leg clip 46. The clip part 47 is folded up out of the plane of the drawing and the part 48 is folded down. The clip 46 is used in instances where four grid members intersect at a common center and, unlike an ordinary rectangular grid, the grid runners are not orthogonal.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A sheet metal clip for connecting the ends of three grid runners with their longitudinal axii intersecting at a common center and at obtuse or acute angles relative to each other, the clip having a leg for each one of the grid runners, each leg, in use, extending in a vertical plane from the center and being permanently bendable at the center to allow the leg to be adjusted to a desired angle of a respective grid runner.

2. A clip as set forth in claim 1, wherein each leg is proportioned to fit between a lower flange and an upper reinforcing bulb of a grid runner and has elements to inter-engage with features on an end of the respective grid runner to restrain the respective grid runner vertically and laterally.

3. A clip as set forth in claim 2, wherein the legs outward of the center are substantially identical.

4. A clip as set forth in claim 3, wherein the legs at their distal ends include a bendable tab adapted to be inserted in a vertical slot in a web of a respective grid runner and, thereafter, bent over the web.

5. A clip as set forth in claim 4, wherein a leg has a weakened zone where the tab joins a remainder of the leg.

6. A clip as set forth in claim 4, wherein the legs include a catch for restraining a forward edge of a grid runner.

7. A clip as set forth in claim 1, wherein the three legs are blanked from a single metal sheet and folded in a manner wherein they remain integral.

8. A clip as set forth in claim 1 having four legs.

9. A clip for connecting three grid runners, the clip being stamped from sheet metal, the clip having three legs joined at a common intersection, each leg having a generally flat major area that in normal use lies in a vertical plane, the metal of the clip being bendable to permit the legs to be field bent adjacent the intersection for adjustment into desired angles relative to one another, distal ends of the legs having bendable tabs, each tab being adapted to be inserted into a vertical slot in a web of a grid runner to be associated with the respective leg, the tab being adapted after being inserted into a slot to be bent over a side of the web opposite the side from which it is inserted in the slot towards the intersection to lock the grid runner in place on the respective leg.

10. A clip as set forth in claim 9, wherein said legs each have a catch between the intersection and the distal end, the catch being arranged to engage an edge of an end of the associated grid runner and to locate the associated grid runner on the respective leg.

11. A clip as set forth in claim 10, wherein the catch is blanked out of the leg to a side of the leg to which the associated tab is bent over.
